(19) United States
(12) Patent Application Publication
(10) Pub. No.: US 2024/0270983 A1
(43) Pub. Date: Aug. 15, 2024

(54) ANTIFOULING COATING FOR THE COMPONENTS OF A HEATING AND COOLING SYSTEM AND ASSOCIATED METHODS

(71) Applicant: Stewart Kaiser, Palm Beach Gardens, FL (US)

(72) Inventor: Stewart Kaiser, Palm Beach Gardens, FL (US)

(73) Assignee: Innovative HVAC Products LLC, West Palm Beach, FL (US)

(21) Appl. No.: 18/622,310

(22) Filed: Mar. 29, 2024

Related U.S. Application Data
(63) Continuation-in-part of application No. 17/897,791, filed on Aug. 29, 2022, now Pat. No. 12,018,178.
Application No. 17/897,791 is a continuation of application No. 17/344,402, filed on Jun. 10, 2021, now Pat. No. 11,427,714.
(60) Provisional application No. 63/205,258, filed on Nov. 30, 2020.
(60) Provisional application No. 63/204,910, filed on Nov. 2, 2020.

(51) Int. Cl. C09D 5/16; C09D 1/00; C09D 5/03

(52) U.S. Cl. CPC C09D 5/1693; C09D 1/00; C09D 5/03; C09D 5/1606

(57) ABSTRACT

A device and method for preventing zooglea growth in an air conditioning system or on one or more components of the air conditioning system is described. The device includes cordage having an antifouling coating made from a polymer infused with metallic particles. The method can include applying the antifouling coating to cordage and inserting the cordage through a condensate pipe of the air conditioning system. The method can include applying the antifouling coating to one or more components of the air conditioning system, including a drainpipe, drain pan, or fitting, and installing the one or more components in the air conditioning system.

### CROSS-REFERENCES TO RELATED APPLICATIONS

This application is a continuation-in-part of U.S. Non-Provisional application Ser. No. 17/897,791 filed on Aug. 29, 2022, which is a continuation of U.S. Non-Provisional application Ser. No. 17/344,402 filed on Jun. 10, 2021, which claims the benefit of U.S. Provisional Application Ser. No. 63/205,258 filed on Nov. 30, 2020, and U.S. Provisional Application Ser. No. 63/204,910 filed on Nov. 2, 2020; the contents of which are relied upon and herein incorporated by reference in their entireties.

### FIELD

This disclosure relates to heating and cooling systems, and more particularly, to an antifouling coating for one or more components of a heating and cooling system, including a condensate drainpipe, and methods of applying the antifouling coating to the one or more components of the heating and cooling systems.

### BACKGROUND

The heating, air conditioning, and refrigeration industry is well-established with known methods and techniques in which the refrigeration process is used to heat and cool structures and keep items cool or frozen. Typical equipment that implements the refrigeration process includes a cold or evaporative side. This side is used to absorb heat from the surrounding air, water, or materials and to transfer the absorbed heat to another location where it is released. The process of absorbing heat through the refrigeration process is a well-known and established practice and used in air conditioning a home.

For example, air is passed through or over an evaporative surface of an air handler that is much colder than the incoming air temperature during an air conditioning cycle for a home. This results in condensation and causes the air holding the moisture to release water droplets on to the colder evaporative surface or coils. The condensation that occurs during the air conditioning cycle dehumidifies the air and is a main feature of air conditioning.

The water from the condensation is collected and flows from the colder surface and drips into a collection drain pan at the bottom of the air handler. A drainpipe is connected to the drain pan that typically discharges outside of the home or directly into a drain line. However, the flow of the water from the drain pan and through the drainpipe is at a relatively slow velocity and can also pool inside the drainpipe. This stagnant water can result in a jelly like bacteria beginning to form known as zooglea.

Zooglea is a gelatinous or mucilaginous mass that is characteristic of the growth of various bacteria when growing in fluid media rich in organic material and is made up of the bodies of the bacteria embedded in a matrix of swollen confluent capsule substance. This jelly like bacterial growth grows within the drainpipe and slows the flow through the pipe and can eventually stop the water flow completely. This blockage causes the water to back up in the drain pan and overflow onto the floor, walls, or ceilings of the structure. This drainage and flooding problem with air handlers is well documented and is the cause for more water damage than any other source.

The industry has attempted to address this problem with the drainpipe in many ways. For example, a float switch can be installed in the drain pan of the air handler, which turns the system off once the water rises to a certain level inside the drain pan. However, this method has proven to be unreliable due to the switch being stuck or to otherwise malfunction so that the system is not turned off. Also, when the water rises near the point where the float switch is configured to turn off the system, the float switch may cause damage to the equipment as the float bounces up and down with the level of the water causing the compressor to start and stop every few minutes. In addition, while a float switch may prevent flooding, it still leaves the owner with a system that is not operating properly. Often this happens in the warmest conditions when the system is running almost continuously and requires a service technician to clear the drainpipe, which can be an expensive service call.

Other attempts to prevent the drainpipe from becoming blocked include placing antibacterial chemical tablets into the drain pan. However, introducing chemicals into the air conditioning system of a home is not ideal. In addition, the tablets often are ineffective within days or weeks of dissolving into the water and do not reliably stop the zooglea growth. Still other attempts include pouring bleach and chemicals directly through the drainpipe or into the drain pan, which causes odors in the home and does not reliably prevent zooglea growth.

Accordingly, there is a need for an improved method and system to prevent or diminish the growth of zooglea in existing drain pans, drainpipes, and other components of air conditioning systems that is safe and effective.

### SUMMARY

In various embodiments, a method for preventing zooglea growth within an air conditioning system is described. In some embodiments, the method comprises: applying an antifouling coating to cordage having a first end and a second end, wherein the antifouling coating comprises a polymer infused with metallic particles; and inserting the cordage through a condensate pipe of the air conditioning system.

In some embodiments, the metallic particles are comprised of silver or copper. In some embodiments, the metallic particles are comprised of silver and copper. In some embodiments, the cordage is woven from a synthetic fiber. In some embodiments, the polymer is polytetrafluoroethylene.

In some embodiments, the first end of the cordage is installed in a drain pan of the air conditioning system. In some embodiments, the second end of the cordage is positioned in an outlet of the condensate pipe.

In various embodiments, a method for preventing microbial growth on one or more components of an air conditioning system is described. In some embodiments, the method comprises: providing the one or more components of the air conditioning system, wherein a respective component of the one or more components is a drainpipe, a drain pan, or a fitting; applying an antifouling coating to the respective component of the one or more components, the antifouling coating comprising a polymer infused with metallic particles; and installing the respective component of the one or more components in the air conditioning system.

In some embodiments, the drainpipe, drain pan, or fitting is made from plastic or metal. In some embodiments, the fitting is a piping elbow or trap. In some embodiments, the metallic particles are comprised of silver or copper. In some embodiments, the metallic particles are comprised of silver and copper.

In some embodiments, the method further comprises applying the antifouling coating to cordage having a first end and a second end; and inserting the cordage through a drainpipe of the air conditioning system. In some embodiments, the first end of the cordage is installed in the drain pan of the air conditioning system. In some embodiments, the second end of the cordage is positioned in an outlet of the condensate pipe.

In various embodiments, a device for preventing zooglea growth in an air conditioning system is described. In some embodiments, the device comprises: cordage comprising an antifouling coating, wherein the antifouling coating comprises a polymer infused with metallic particles.

In some embodiments, the metallic particles are comprised of silver or copper. In some embodiments, the metallic particles are comprised of silver and copper. In some embodiments, the cordage is woven from a synthetic fiber. In some embodiments, the polymer is polytetrafluoroethylene.

In various embodiments, a device for the prevention of zooglea growth in an air conditioning system is disclosed. In some embodiments, the device comprises: cordage having a first end having an anchor for securing within the air conditioning system and a second end, wherein the cordage is configured to be inserted into a pipe of the air conditioning system and extend from a drain pan of the air conditioning system to an outlet of the pipe; and an antifouling coating applied to the cordage.

In some embodiments, the antifouling coating includes a polymer and a metallic powder. In some embodiments, the metallic powder includes copper. In some embodiments, the metallic powder includes silver. In some embodiments, the anchor includes a sleeve clamped to the first end. In some embodiments, the sleeve is copper. In some embodiments, the sleeve is configured for retention in a drain pan outlet. In some embodiments, the sleeve is deformable by crimping. In some embodiments, the cordage is woven from a synthetic fiber. In some embodiments, the first end of the cordage is secured to the air conditioning system and the cordage extends through the condensate drainpipe.

In various embodiments, a method for preventing or reducing microbial growth or existence in an air conditioning system is disclosed. In some embodiments, the method comprises: providing an antifouling cordage, wherein the cordage comprises a coating that prevents or reduces the microbial growth or existence; and inserting the cordage through a pipe of the air conditioning system that conveys a liquid from a drain pan of the air conditioning system to an outlet of the pipe, wherein the cordage extends through the pipe from the drain pan to the outlet. In some embodiments, the liquid is a condensate. In some embodiments, the condensate is sourced from an air conditioning system. In some embodiments, the method further comprises securing the cordage such that the liquid passes by the cordage and is exposed to the coating that prevents or reduces the microbial growth or existence in the pipe. In some embodiments, the microbial growth or existence includes a zooglea growth or existence. In some embodiments, the cordage is rope. In some embodiments, the cordage is left inside the pipe. In some embodiments, the outlet of the pipe is located outside of a wall of a home encompassing the air conditioning system.

In various embodiments, a method for the prevention of zooglea growth within an air conditioning system is disclosed. The method includes applying an antifouling coating to an interior of a condensate pipe of the air conditioning system, where the antifouling coating comprises a base layer of an algaecide, an intermediate layer of a hydrophobic polymer, and a top layer of a metallic powder. The metallic powder may be a mixture of silver and copper, and the hydrophobic polymer may be polytetrafluoroethylene (PTFE). The method may also include applying the antifouling coating to a drainage pan of the air conditioning system.

In some embodiments, the applying of the antifouling coating to the condensate pipe includes pouring the algaecide coating into the condensate pipe, spinning the condensate pipe to apply the algaecide coating to an interior surface of the condensate pipe, and drying the algaecide coating. The method also includes pouring the hydrophobic polymer into the condensate pipe, spinning the condensate pipe to apply the hydrophobic polymer over the algaecide coating, partially drying the hydrophobic polymer, and pouring the metallic powder into the condensate pipe. In addition, the method includes spinning the condensate pipe to apply the metallic powder over the hydrophobic polymer, and drying the hydrophobic polymer until the metallic powder is embedded.

In various embodiments, a method for the prevention of zooglea growth within an air conditioning system includes applying an antifouling coating to cordage having a first end and a second end, where the antifouling coating comprises a base layer of an algaecide, and a top layer of metallic powder. The method includes inserting the cordage through a condensate pipe of the air conditioning system. In addition, the method includes inserting a first end of the cordage through a copper sleeve and securing the first end of the cordage inside the copper sleeve, where an exterior of the copper sleeve extends partially from the condensate pipe in order to anchor the first end of the cordage to an open end of the condensate pipe. The copper sleeve may comprise a mesh.

In some embodiments, an antifouling coating for the prevention of zooglea growth within an air conditioning system is disclosed. The antifouling coating includes a base layer comprising an algaecide, an intermediate layer comprising a hydrophobic polymer, and a top layer comprising metallic powder.

In various embodiments, a device for the prevention of zooglea growth within an air conditioning system is disclosed and includes cordage having a first end and a second end, and an antifouling coating applied to the cordage. The antifouling coating comprises a base layer of an algaecide, and a top layer of metallic powder. The device also includes a copper sleeve secured to the first end of the cordage, where the copper sleeve may comprise a mesh. The cordage may comprise a natural fiber material or a synthetic fiber material, or a combination of both.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein and, together with the description, explain the principles and operations of the claimed subject matter.

### BRIEF DESCRIPTION OF THE DRAWINGS

A complete understanding of the present embodiments and the advantages and features thereof will be more readily understood by reference to the following detailed description, appended claims, and accompanying drawings, wherein:

FIG. 1 is a schematic of an air conditioning system and condensate drainpipe in which various aspects of the disclosure may be implemented.

FIG. 2 is a schematic of a portion of the drainpipe having an antifouling coating, in accordance with embodiments disclosed herein.

FIG. 3 is a schematic of a drain pan of the air conditioning system of FIG. 1 having the antifouling coating.

FIG. 4 is a cross section of the antifouling coating.

FIG. 5 is a schematic of cordage having the antifouling coating and being pulled through the drainpipe.

FIG. 6 is a schematic of a first end of the cordage being pulled through a sleeve, in accordance with embodiments disclosed herein.

FIG. 7 is a schematic of the sleeve being secured to the cordage.

FIG. 8 is a schematic of the sleeve secured to an outlet of the drain pan.

FIG. 9 is a flowchart of a method of applying the antifouling coating to the drainpipe.

The drawings are not necessarily to scale, and certain features and certain views of the drawings may be shown exaggerated in scale or in schematic in the interest of clarity and conciseness.

### DETAILED DESCRIPTION

Reference will now be made in detail to the exemplary embodiment(s), examples of which is/are illustrated in the examples. The specific details of the various embodiments described herein are used for demonstration purposes only, and no unnecessary limitation or inferences are to be understood therefrom. Before describing the exemplary embodiments, it is noted the embodiments reside primarily in combinations of components, subcomponents, and procedures related to the antifouling coatings and methods of applying the coatings to one or more components of heating and cooling systems. Accordingly, the product and method components have been represented where appropriate, showing only those specific details that are pertinent to understanding the embodiments of the present disclosure so as not to obscure the disclosure with details that will be readily apparent to those of ordinary skill in the art having the benefit of the description herein.

In the summary, provided above, and in the descriptions of certain preferred embodiments, reference is made to particular features, for example, method steps. It is to be understood that the disclosure includes all possible combinations of such features, regardless of whether a combination is explicitly described. For instance, where a particular feature is disclosed in the context of a particular aspect or embodiment, that feature can also be used, to the extent possible, in combination with and/or in the context of other aspects and embodiments.

An object of the various embodiments is to provide a drainage pipe and fittings that are permanently treated with a specially formulated coating which by way of its own unique properties, permanently prevents the growth of zooglea within the drainage system. The coating is comprised of a hydrophobic polymer such as polytetrafluoroethylene (PTFE) which causes extremely low tension between the walls of the pipe and the drain water. This beading effect causes the molecules of the water to bead together and way from the pipe surface. Another object of the coating is to include anti-fouling, anti-microbial and anti-viral substances within the coating which helps prevent growth in the standing water. Some of the most significant properties of the coating is infused copper and silver particles and powder. The unique properties have a physical effect on the zooglea before it can grow to a gelatinous state. Silver ions perform their deadly work by punching holes in bacterial membranes and wreaking havoc once inside. In addition, they bind to essential cell components like DNA, preventing the bacteria from performing even their most basic functions. Accordingly, copper alloy having silver has a significant effect on the growth of bacteria, molds, fungi, spores, viruses, prokaryotic and eukaryotic microorganisms. This overall method is known as the oligodynamic effect.

The coating of various embodiments, when used in new drainage systems will provide a lifetime of protection from the growth of zooglea among many other bacterial and viral growths which would be deemed unhealthy and potentially dangerous to humans including but not limited to pathogens like legionary's disease. The standing water inside a drainage system acts similar to an incubator for almost every form of unwanted growth.

The coated piping can be used with conventional PVC piping and alleviates concerns from future clogs and water damage. In many cases, old piping can be easily replaced with the new treated and coated piping to prevent future clogs and water damage on older systems.

An aspect of various embodiments is the process in which the coatings, treatments and infusions of the topical metallic powder coats are applied during the manufacturing process. For example, initially the drainpipe, which can be made from PVC, may be roughened with a steel wool circular brush in the internal section of the pipe. A stopper is placed on each end of the pipe and a tube placed through the stopper. In some embodiments, a first layer of the antifouling coating (e.g., algaecide) is poured down into the pipe through the tube. Once filled, the pipe is spun to force the algaecide against the rough walls of the pipe using centrifugal force. After several minutes, the remaining algaecide that does not adhere to the walls of the pipe is drained. The drainpipe is placed in a drying chamber or high temperature low humidity oven for several minutes.

In some embodiments, a second layer of the antifouling coating of a hydrophobic polymer (e.g., PTFE) is poured into the drainpipe. Again, the pipe is spun at high velocity for several minutes, forcing the second layer to embed into the underlying first layer. Once again, the remaining hydrophobic polymer is drained from the pipe. The pipe is placed back into the drying chamber.

Once the second layer of the hydrophobic polymer becomes tacky and partially dried, the pipe is removed from the drying chamber. The pipe is placed upright, and the top stopper is removed. In some embodiments, a fifty percent mixture of silver powder and copper powder may be poured into the pipe until filled. The stopper is placed back on the pipe. The pipe is spun at high velocity causing the powder mixture to imbed itself as a topical into the underlying second layer or tackifier coating. After several minutes, the remaining powder mixture is poured out of the pipe. The stoppers are placed back on the pipe and the pipe is placed back into the drying chamber for several hours or until sufficiently dried. The pipe is the taken out and placed on a shaker. The stopper removed and the pipe is shaken abruptly for several minutes until all the powder residue that is not adhered to the pipe is shaken away. The pipe is now ready for use.

An objective of various embodiments is to provide a coating, a method of applying the coating to piping and related fittings, and a method of using the coated piping in the heating, ventilating and air conditioning (HVAC) field amongst any other industries which could benefit from such embodiments.

The antifouling coating may be comprised of a mixture of chemicals in various percentages so that the percentages provided herein are exemplary rather than limiting. As described above, the antifouling coating includes a hydrophobic polymer (e.g., PTFE) based coating capable of adhering to construction and piping materials such as plastics, PVC and metals. An intermediate second layer of an anti-fungal chemical coating, an anti-bacterial chemical coating, and/or an anti-viral chemical coating is applied over the hydrophobic polymer. These two layers in various percentages form the base for the coating mixture. In addition, a metallic powder of copper and/or silver is added to the coating in various relative percentages. As those of ordinary skill in the art can appreciate, many metallic and anti-microbial substances can be used. Furthermore, though certain viscous and anti-microbial coatings have been described, any chemical which demonstrates those properties may be used in any percentage or combination with the antifouling coating of various embodiments disclosed herein.

In some embodiments, a mixture (e.g., fifty percent mixture) of metallic (e.g., silver and copper) powder is poured into a container of the antifouling coating (e.g., algaecide). The mixture is stirred, shaken, or otherwise mixed to disperse and infuse the powder throughout the antifouling coating. The mixture can then be poured into a drainpipe or another heating and cooling system component (e.g., trap, elbow). Once filled, the drainpipe or other component can be agitated (e.g., spun) to adhere the mixture against the rough wall surfaces of the drainpipe or other components. After several minutes, any remaining mixture that does not adhere to the walls of the drainpipe or other component can be drained. Alternatively, the drainpipe or other component can be inserted and submerged in the container having the mixture of metallic powder and antifouling coating. Once the drainpipe or other component is submerged, the mixture can adhere to the internal surface. After several minutes, the drainpipe or other component can be removed and any excess mixture can be drained into the container. Next, the drainpipe or other component can be placed in a drying chamber or high temperature, low humidity oven for several minutes. The process can be repeated one or more times as needed.

In another aspect, the antifouling coating can be applied to cordage (e.g. rope). The cordage can be installed in an existing drainpipe from the drain pan to the outlet of the drainpipe in order to prevent the growth of any microbial and more defined zooglea. The cordage is left inside the drainpipe and can be removed once the antifouling coating has deteriorated. In addition, a copper sleeve can be used to secure one end of the cordage to the drain pan of the air conditioning system, and which also helps to prevent the growth of microbial or more defined zooglea in the inlets and outlets of the drainage system.

Referring now to FIG. 1, a schematic of a typical air conditioning system 102 and condensate drainpipe 104 is shown. The condensate water drains from the air conditioner 102, through the trap 103, the drainpipe 104, and a plurality of elbows 105; and the condensate water 110 flows out of the outlet 108 located outside of a wall 106 of a home.

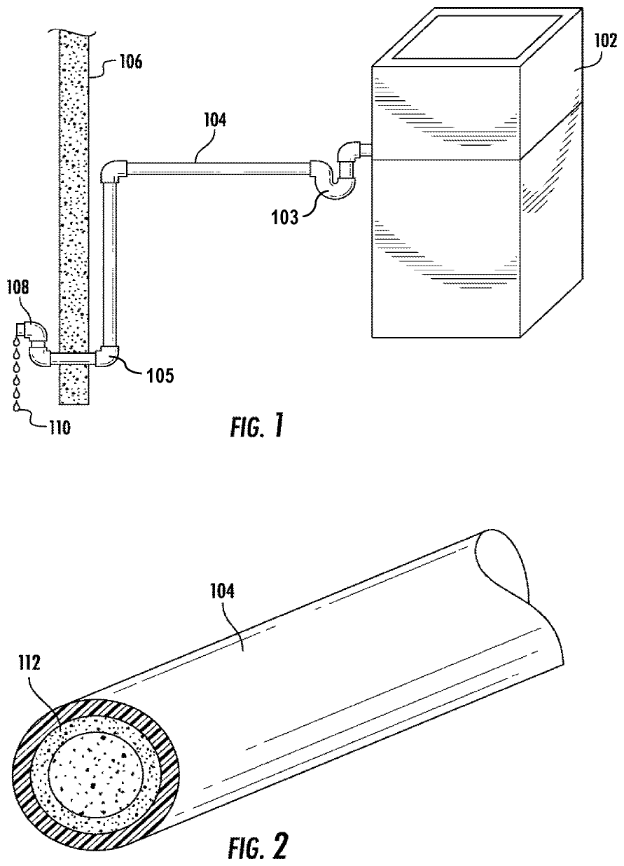

FIG. 2 is a schematic of a portion of the drainpipe 104 having an antifouling coating 112 applied to the interior walls of the drainpipe 104. FIG. 3 is a schematic of a drain pan 114 of the air conditioning system having the antifouling coating 112 applied to its surface. The antifouling coating 112 can also be applied to various fittings wherever the condensate water 110 may reach. As explained above, in some embodiments the antifouling coating 112 includes a polymer infused with metallic particles. In some embodiments, the metallic particles are comprised of silver or copper.

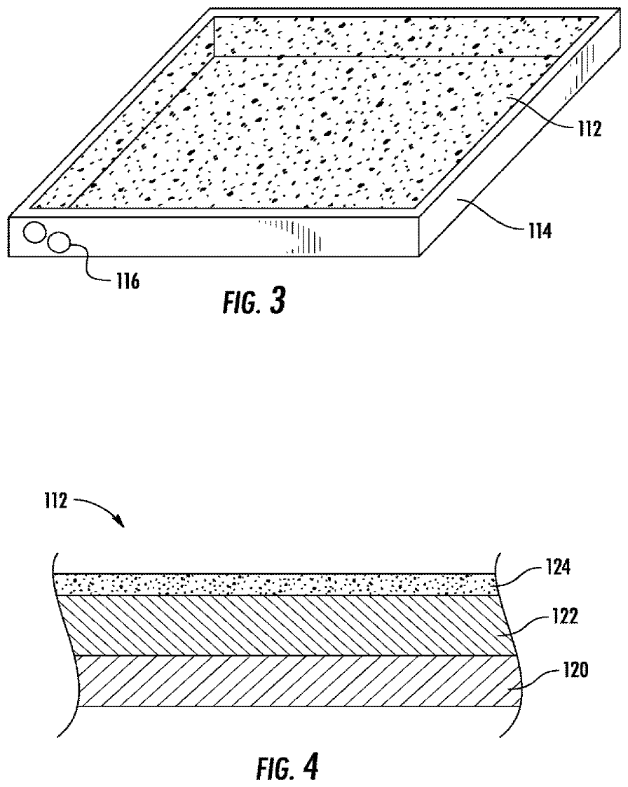

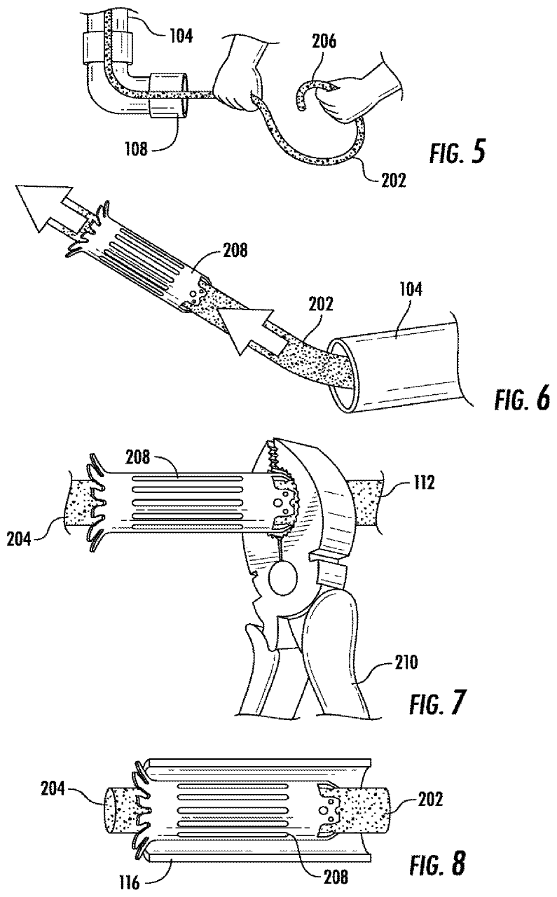

As explained above, in some embodiments the antifouling coating 112 includes three layers as shown in FIG. 4. The base layer 120 of algaecide is the first layer to be applied to a surface. The intermediate layer is the hydrophobic polymer 122 that is applied over the base layer 120. The top layer 124 is a metallic powder that can be partially embedded within the intermediate layer 124.

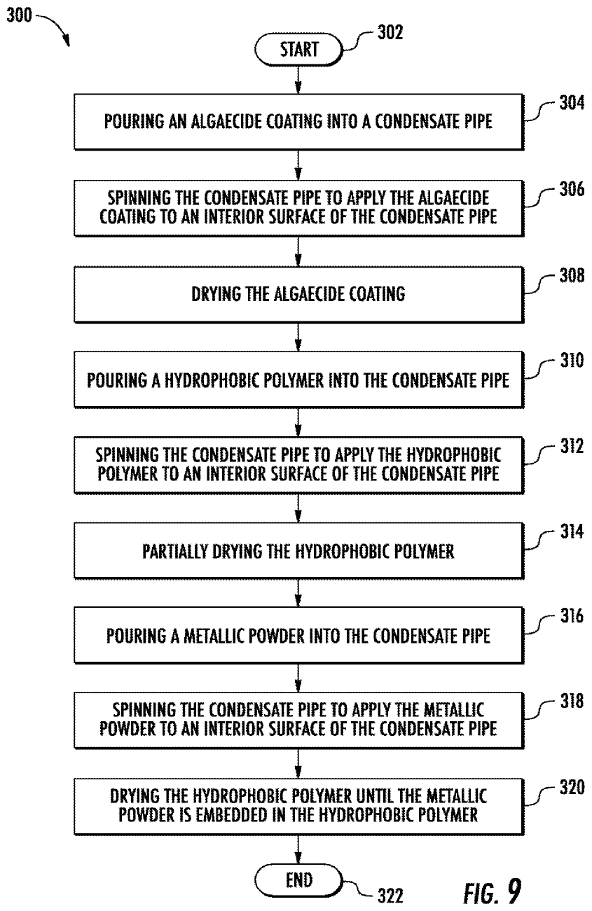

Referring now to FIG. 5, a schematic of cordage 202 having the antifouling coating 112 is shown and being pulled through the drainpipe 104 with the second end 206 extending out from the outlet 108 of the drainpipe 104. In some embodiments, the first end 204 of the cordage 202 is pushed or pulled through the sleeve 209. Once the sleeve 208 is in the proper position, the sleeve 208 is secured to the first end 204 of the cordage 202 as shown in FIG. 7 using a crimping tool 210. In some embodiments, the opposing end of the sleeve 208 is secured to the open end of the drain pan outlet 116 as shown in FIG. 8.

Referring now to FIG. 9, a flowchart of a method of applying the antifouling coating to the drainpipe is depicted. In some embodiments, the method 300 begins at 302 with pouring the algaecide coating into the condensate pipe, at 304. In some embodiments, the method includes, at 306, spinning the condensate pipe to apply the algaecide coating to an interior surface of the condensate pipe, and drying the algaecide coating, at 308. In some embodiments, the method also includes, at 310, pouring the hydrophobic polymer into the condensate pipe, spinning the condensate pipe, at 312, to apply the hydrophobic polymer over the algaecide coating, and partially drying the hydrophobic polymer, at 314. In some embodiments, at 316, the method includes pouring the metallic powder into the condensate pipe, spinning the condensate pipe, at 318, to apply the metallic powder over the hydrophobic polymer, and drying the hydrophobic polymer, at 320, until the metallic powder is embedded in the hydrophobic polymer. The method ends at 322.

The foregoing embodiments are provided to aid in the understanding of the present disclosure, the true scope of which is set forth in the appended claims. One of skill in the art would appreciate that modifications can be made in the embodiments set forth without departing from the spirit of the disclosure.

Exemplary embodiments and examples of the coating and methods are described above in detail. The coating and/or methods are not limited to the specific embodiments described herein, but rather, components of the coating and/or steps of the method may be utilized independently and separately from other components and/or steps described herein. For example, the coating may also be used in combination with other components and/or methods and are not limited to practice with only the heating and cooling components as described herein. Rather, the exemplary embodiment can be implemented and utilized in connection with many other systems.

As used herein, the use of examples, or exemplary language (e.g., “such as”), is intended to illuminate the embodiments and does not pose a limitation on the scope of the claims unless otherwise stated. No language in the specification should be construed as indicating any non-claimed element as essential.

This written description uses examples to disclose the present embodiments, including the best mode, and to enable any person skilled in the art to practice the present embodiments, including carrying out the steps of the method. The patentable scope of the present embodiments is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

I/we claim:

1. A method for preventing zooglea growth within an air conditioning system, the method comprising:
applying an antifouling coating to cordage having a first end and a second end, wherein the antifouling coating comprises a polymer infused with metallic particles; and
inserting the cordage through a condensate pipe of the air conditioning system.

2. The method of claim 1, wherein the metallic particles are comprised of silver or copper.

3. The method of claim 1, wherein the metallic particles are comprised of silver and copper.

4. The method of claim 1, wherein the cordage is woven from a synthetic fiber.

5. The method of claim 1, wherein the first end of the cordage is installed in a drain pan of the air conditioning system.

6. The method of claim 5, wherein the second end of the cordage is positioned in an outlet of the condensate pipe.

7. The method of claim 1, wherein the polymer is polytetrafluoroethylene.

8. A method for preventing microbial growth on one or more components of an air conditioning system, the method comprising:
providing the one or more components of the air conditioning system, wherein a respective component of the one or more components is a drainpipe, a drain pan, or a fitting;
applying an antifouling coating to the respective component of the one or more components, the antifouling coating comprising a polymer infused with metallic particles; and
installing the respective component of the one or more components in the air conditioning system.

9. The method of claim 1, wherein the drainpipe, drain pan, or fitting is made from plastic or metal.

10. The method of claim 1, wherein the fitting is a piping elbow or trap.

11. The method of claim 8, wherein the metallic particles are comprised of silver or copper.

12. The method of claim 8, wherein the metallic particles are comprised of silver and copper.

13. The method of claim 8, further comprising applying the antifouling coating to cordage having a first end and a second end; and
inserting the cordage through a drainpipe of the air conditioning system.

14. The method of claim 13, wherein the first end of the cordage is installed in the drain pan of the air conditioning system.

15. The method of claim 14, wherein the second end of the cordage is positioned in an outlet of the condensate pipe.

16. A device for preventing zooglea growth in an air conditioning system, the device comprising:
cordage comprising an antifouling coating, wherein the antifouling coating comprises a polymer infused with metallic particles.

17. The device of claim 16, wherein the metallic particles are comprised of silver or copper.

18. The device of claim 16, wherein the metallic particles are comprised of silver and copper.

19. The device of claim 16, wherein the cordage is woven from a synthetic fiber.

20. The device of claim 16, wherein the polymer is polytetrafluoroethylene.
